(19) United States
(12) Patent Application Publication
(10) Pub. No.: US 2026/0156576 A1
(43) Pub. Date: Jun. 4, 2026

(54) METHOD, APPARATUS, AND SYSTEM FOR COMMUNICATION DEVICE WAKE-UP

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/456,746

(22) Filed: Jan. 22, 2026

Related U.S. Application Data
(63) Continuation of application No. PCT/CN2024/083961, filed on Mar. 27, 2024.
(60) Provisional application No. 63/515,194, filed on Jul. 24, 2023.

(51) Int. Cl. H04W 52/02; H04J 13/00; H04W 64/00

(52) U.S. Cl. CPC H04W 52/0235; H04J 13/0062; H04W 64/00

(57) ABSTRACT

Embodiments of the present application provide a communication method and a communication apparatus. The method includes: receiving, in a first mode, a wake-up signal (WUS), where a parameter of the WUS is associated with a location identifier; and transitioning from the first mode to a second mode based on the parameter of the WUS and a location identifier of the receiving apparatus, where the location identifier of the receiving apparatus indicates a location of the receiving apparatus. One or more of receiving apparatuses (nodes) associated with the location identifier can use the same WUS for a WU procedure.

### CROSS-REFERENCE TO RELATED APPLICATIONS

The present application is a continuation of International Patent Application PCT/CN2024/083961, entitled “Method, Apparatus, and System for Communication Device Wake-up,” filed on Mar. 27, 2024, which claims the benefit of U.S. Patent Application No. 63/515,194, entitled “Methods, Apparatus, and Systems for Location-based Wake-Up Signal,” filed on Jul. 24, 2023.

The entire contents of the aforementioned applications are hereby incorporated by reference.

### TECHNICAL FIELD

Embodiments of the present application relate to the field of communications, and more specifically, to a communication method and a communication apparatus.

### BACKGROUND

In a communication system, a node may transition into a low-power mode (for example, an idle mode, an inactive mode or other low-power modes) to reduce the power consumption. A node in the low-power mode monitors the wake-up signal (WUS), where the WUS is used to trigger the node to exit the low-power mode. This procedure in which a node is woken up may be called a wake-up (WU) procedure. Due to the possible high demand for WU, a pool of WUSs having multiple WUSs with different parameters can be designed, and the WUSs in the pool can be associated with identities of different nodes separately, so that different nodes use different WUSs for the WU procedure.

In order to serve a large number of nodes, the pool of WUSs can be expanded by adding more possible WUSs. However, expanding the pool of WUSs may increase resource overhead which is not desired and/or degrade the WU procedure performance by increasing WU false alarm probability. Therefore, how to provide WU service for a large number of nodes without performance degradation or resource overhead becomes an urgent problem to be solved.

### SUMMARY

Embodiments of the present application provide a communication method and a communication apparatus. The technical solutions may provide WU service for a large number of nodes without performance degradation or resource overhead.

According to a first aspect, an embodiment of the present application provides a communication method, and the method may be performed by a receiving apparatus. The method includes: receiving, in a first mode, a wake-up signal (WUS), where a parameter of the WUS is associated with a location identifier; and transitioning from the first mode to a second mode based on the parameter of the WUS and a location identifier of the receiving apparatus, where the location identifier of the receiving apparatus indicates a location of the receiving apparatus.

According to a second aspect, an embodiment of the present application provides a communication method, and the method may be performed by a transmitting apparatus. The method includes: transmitting a wake-up signal (WUS), where a parameter of the WUS is associated with a location identifier, the parameter of the WUS is used for a receiving apparatus to transition from a first mode to a second mode based on a location identifier of the receiving apparatus, and the location identifier of the receiving apparatus indicates a location of the receiving apparatus.

According to the above technical solution, at least one parameter of the WUS is associated with a location identifier, so that one or more of receiving apparatuses (nodes) associated with the location identifier can use the same WUS for a WU procedure. That is, WUSs in the pool of WUSs can be used by more nodes without adding new WUSs. Thus, WU procedure can be provided for a large number of nodes without performance degradation or resource overhead.

With reference to the first aspect, in some embodiments, the transitioning from the first mode to a second mode based on the parameter of the WUS and a location identifier of the receiving apparatus includes: obtaining a configuration parameter associated with the receiving apparatus based on a mapping function and the location identifier of the receiving apparatus, where an input of the mapping function includes the location identifier, and an output of the mapping function includes the configuration parameter; and transitioning from the first mode to the second mode based on the parameter of the WUS and the configuration parameter associated with the receiving apparatus.

With reference to the second aspect, in some embodiments, the parameter of the WUS is used for the receiving apparatus to transition from the first mode to the second mode based on a configuration parameter associated with the receiving apparatus, the configuration parameter associated with the receiving apparatus is obtained based on a mapping function and the location identifier of the receiving apparatus, an input of the mapping function includes the location identifier, and an output of the mapping function includes the configuration parameter.

According to the above technical solution, the configuration parameter associated with the receiving apparatus can be obtained by a mapping function based on the location identifier of the receiving apparatus, so that the receiving apparatus can receive the mapping function instead of the specific configuration parameter because the receiving apparatus has the knowledge of its own location. Thus, the process of configuring the WUS can be simplified.

With reference to the first aspect or the second aspect, the WUS includes at least one linear frequency modulated (LFM) signal, and the parameter of the WUS includes at least one or more of the following: an LFM rate of the at least one LFM signal, an initial frequency of the at least one LFM signal, a time duration of the at least one LFM signal, and an initial time of the at least one LFM signal.

According to the above technical solution, the WUS can be generated based on the LFM signal and the LFM signal has an advantage in terms of low complexity processing. Thus, complexity and power consumption of the WU procedure can be reduced.

With reference to the first aspect or the second aspect, in some embodiments, the WUS includes a Zadoff-Chu (ZC) sequence, and the parameter of the WUS includes at least one or more of the following: a root of the ZC sequence, a length of the ZC sequence, and a cyclic shift value of the ZC sequence.

According to the above technical solution, the WUS can be generated based on the ZC sequence and the ZC sequence has an advantage in terms of power efficiency and hardware. Thus, efficiency of the WU procedure can be increased.

With reference to the first aspect or the second aspect, in some embodiments, the location identifier of the receiving apparatus includes a coordinate of the location of the receiving apparatus in a two-dimensional or three-dimensional coordinate system with a reference point as an origin.

According to the above technical solution, the location identifier can be an exact coordinate of the receiving apparatus in a rectangular coordinate system.

With reference to the first aspect or the second aspect, in some embodiments, the location identifier of the receiving apparatus includes an identifier of a location region, where the receiving apparatus is located in the location region.

According to the above technical solution, the location identifier can be a coarse approximation of the location of the receiving apparatus in a rectangular coordinate system.

With reference to the first aspect or the second aspect, in some embodiments, the location identifier of the receiving apparatus includes an angle between the location of the receiving apparatus and a reference point measured with respect to a reference direction.

According to the above technical solution, the location identifier can be an exact coordinate of the receiving apparatus in a polar coordinate system.

With reference to the first aspect or the second aspect, in some embodiments, the location identifier of the receiving apparatus includes an identifier of an angular region, where the angular region is located between a first direction and a second direction with respect to a reference point, and the receiving apparatus is located in the angular region.

According to the above technical solution, the location identifier can be a coarse approximation of the location of the receiving apparatus in a polar coordinate system.

With reference to the first aspect or the second aspect, in some embodiments, the WUS is transmitted with a first beam among multiple beams, where the multiple beams cover different locations, and the first beam covers the location of the receiving apparatus.

According to the above technical solution, WUSs having the same parameter can be separated by being transmitted with different beams, so that a parameter of a WUS can be associated with multiple different location identifiers. That is, a WUS can be re-used by multiple receiving apparatuses with different location identifiers. Thus, the WU procedure can be provided for more nodes without performance degradation or resource overhead.

With reference to the first aspect, in some embodiments, the WUS is transmitted with a timing advance, where the timing advance is associated with a distance between the receiving apparatus and a transmitting apparatus transmitting the WUS, and the transitioning from the first mode to a second mode based on the parameter of the WUS and a location identifier of the receiving apparatus includes: obtaining an estimated range based on the WUS, where the estimated range is associated with the timing advance and the distance between the receiving apparatus and the transmitting apparatus, and the estimated range is less than a first threshold; and transitioning from the first mode to the second mode based on the estimated range, the parameter of the WUS and the location identifier of the receiving apparatus.

With reference to the second aspect, in some embodiments, the WUS is transmitted with a timing advance, where the timing advance is associated with a distance between the receiving apparatus and the transmitting apparatus, an estimated range obtained by the receiving apparatus based on the WUS is associated with the timing advance and the distance between the receiving apparatus and the transmitting apparatus, and the estimated range is less than a first threshold.

According to the above technical solution, WUSs having the same parameter can be separated by applying different timing advances at the transmitting apparatus, so that a parameter of a WUS can be associated with multiple different location identifiers. That is, a WUS can be re-used by multiple receiving apparatuses with different location identifiers. Thus, the WU procedure can be provided for more nodes without performance degradation or resource overhead.

With reference to the first aspect or the second aspect, in some embodiments, the WUS is transmitted with an intended depth, where a difference between the intended depth and a radial distance of the receiving apparatus is less than a second threshold, and the radial distance of the receiving apparatus is a distance between the receiving apparatus and a transmitting apparatus transmitting the WUS.

According to the above technical solution, WUSs having the same parameter can be separated by being transmitted to different intended depths, so that a parameter of a WUS can be associated with multiple different location identifiers. That is, a WUS can be re-used by multiple receiving apparatuses with different location identifiers. Thus, the WU procedure can be provided for more nodes without performance degradation or resource overhead.

With reference to the first aspect, in some embodiments, the method further includes: receiving configuration information, where the configuration information indicates a configuration parameter of the WUS, and the configuration parameter of the WUS is associated with the location identifier of the receiving apparatus.

With reference to the second aspect, in some embodiments, the method further includes: transmitting configuration information, where the configuration information indicates a configuration parameter of the WUS, and the configuration parameter of the WUS is associated with the location identifier of the receiving apparatus.

According to the above technical solution, the receiving apparatus can process the WUS based on the configuration information, to determine to transition from the first mode to the second mode. Thus, the reliability of the WU procedure can be improved.

With reference to the first aspect or the second aspect, in some embodiments, the configuration information includes a mapping function, where an input of the mapping function includes the location identifier, and an output of the mapping function includes the configuration parameter.

According to the above technical solution, the configuration information can include the mapping function instead of the specific configuration parameter because the receiving apparatus has the knowledge of its own location. Thus, the structure of the configuration information can be simplified.

With reference to the first aspect or the second aspect, in some embodiments, the configuration information indicates that the WUS is transmitted with a timing advance.

According to the above technical solution, the receiving apparatus can know that a timing advance will be applied in the WUS, so that the receiving apparatus can estimate its range from the transmitting apparatus by processing the WUS before determining to transition from the first mode to the second mode. Thus, the WU false alarm probability can be reduced.

With reference to the first aspect or the second aspect, in some embodiments, the configuration information indicates a first threshold, where an estimated range obtained by the receiving apparatus based on the WUS is less than the first threshold, and the estimated range is associated with the timing advance and the distance between the receiving apparatus and a transmitting apparatus transmitting the WUS.

According to the above technical solution, the receiving apparatus can know how to detect its own WUS when the TA is applied to the WUS. Thus, the WU false alarm probability can be reduced.

With reference to the first aspect or the second aspect, in some embodiments, the WUS includes a prefix part, where a timing offset of the WUS is obtained based on the prefix part, and the parameter of the WUS is obtained based on the timing offset.

According to the above technical solution, synchronization can be performed as a part of the WU procedure. Thus, the reliability of the WU procedure can be improved.

With reference to the first aspect or the second aspect, the parameter of the WUS is associated with an identity of the receiving apparatus.

According to the above technical solution, different receiving apparatuses associated with the same location identifier can use different configurations of the WUS.

With reference to the first aspect or the second aspect, in some embodiments, power consumption corresponding to the first mode is lower than power consumption corresponding to the second mode.

According to the above technical solution, for example, the first mode may be an idle mode (or state), an inactive mode (or state), or other low-power consumption modes. The second mode may be a connected mode (or state) or other modes with higher power consumption than the first mode.

According to a third aspect, a receiving apparatus is provided. The receiving apparatus includes a function or unit configured to perform the method according to the first aspect or any one of the possible embodiments of the first aspect.

For example, the receiving apparatus could be a terminal device or a chip in the terminal device. For another example, the receiving apparatus could be a network device or a chip in the network device.

According to a fourth aspect, a transmitting apparatus is provided. The transmitting apparatus includes a function or unit configured to perform the method according to the second aspect or any one of the possible embodiments of the second aspect.

For example, the transmitting apparatus could be a network device or a chip in the network device. For another example, the transmitting apparatus could be a terminal device or a chip in the terminal device.

According to a fifth aspect, a system is provided. The system includes: the receiving apparatus according to the third aspect and the transmitting apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a receiving apparatus. For example, the communication apparatus may be a terminal device or a component (for example, a chip or integrated circuit) installed in the terminal device. For another example, the communication apparatus may be a network device or a component (for example, a chip or integrated circuit) installed in the network device.

With reference to the sixth aspect, in some implementations of the sixth aspect, the communication apparatus may be a transmitting apparatus. For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute one or more instructions, and the communications interface is configured to communicate with other network elements under the control of the processor. The processor is enabled to perform the method according to the first aspect or any one of the possible embodiments of the first aspect, or the second aspect or any one of the possible embodiments of the second aspect.

According to an eighth aspect, a computer storage medium is provided. The computer storage medium stores program code, and the program code is used to execute one or more instructions for the method according to the first aspect or any one of the possible embodiments of the first aspect, or the second aspect or any one of the possible embodiments of the second aspect.

According to a ninth aspect, this application provides a computer program product including one or more instructions, where when the computer program product runs on a computer, the computer performs the method according to the first aspect or any one of the possible embodiments of the first aspect, or the second aspect or any one of the possible embodiments of the second aspect.

### DESCRIPTION OF DRAWINGS

FIG. 1 is a schematic diagram of an application scenario according to this application;

FIG. 2 illustrates an example communication system 100;

FIG. 3 illustrates another example of an ED and a base station;

FIG. 4 is a schematic flowchart of a communication method 400 according to an embodiment of this application;

FIG. 5 is a schematic diagram of one LFM signal;

FIG. 6 is a schematic diagram of an example of an LFM-based signal;

FIG. 7 illustrates an example of a location identifier indicating a coarse approximation of a location of a receiving apparatus in a two-dimensional space;

FIG. 8 illustrates a first example of an angular direction;

FIG. 9 illustrates an example of a location identifier indicating a coarse approximation of an angular direction of a receiving apparatus;

FIG. 10 illustrates an example of a WU procedure at a transmitting apparatus side according to an embodiment of this application;

FIG. 11A illustrates an example of re-using a WUS configuration in different LRs;

FIG. 11B illustrates another example of re-using WUS configuration in different LRs;

FIG. 12 illustrates another example of re-using a WUS configuration in different LRs;

FIG. 13 illustrates an example of re-using a WUS configuration in different ARs;

FIG. 14 illustrates an example of separating WUSs by different beams;

FIG. 15 illustrates another example of separating WUSs by different beams;

FIG. 16 illustrates an example of separating WUSs by different TAs;

FIG. 17 illustrates another example of separating WUSs by different TAs;

FIG. 18 illustrates an example of separating WUSs by different beams and TAs;

FIG. 19 illustrates an example of separating WUSs by different intended depths;

FIG. 20 illustrates an example of a WU procedure at a receiving apparatus side according to an embodiment of this application;

FIGS. 21-25 are schematic block diagrams of possible devices according to embodiments of this application.

### DESCRIPTION OF EMBODIMENTS

The following describes technical solutions of the present application with reference to the accompanying drawings.

The technical solutions in embodiments of this application may be applied to various communication systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new ratio (NR) wireless communications system, a sixth generation (6G) wireless communications system, integrated access and backhaul (IAB) system, a mesh network, a side link system, or other evolving communication systems. The technical solutions in embodiments of this application may be applied to the communication system that integrates the above two or more systems.

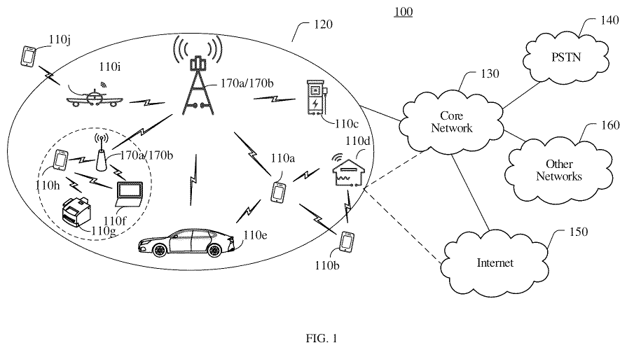

For ease of understanding the embodiments of this application, a communications system shown in FIGS. 1-3 is first used as an example to describe in detail a communications system to which the embodiments of this application are applicable.

FIG. 1 is a schematic diagram of an application scenario according to this application. Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 further includes a public switched telephone network (PSTN) 140, the Internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered as sub-systems of the communication system. In the example shown, the communication system 100 includes electronic devices (ED) 110a-110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination thereof. In some examples, the ED 110a may communicate an uplink and/or downlink transmission over an interface 190a with the T-TRP 170a. In some examples, the EDs 110a, 110b and 110d may also communicate directly with one another via one or more sidelink air interfaces 190b. In some examples, the ED 110d may communicate an uplink and/or downlink transmission over an interface 190c with the NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or more NT-TRPs 172 via a wireless link or simply a link. For some examples, the link is a dedicated connection for unicast transmission, a connection for broadcast transmission, or a connection between a group of EDs and one or more NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by the core network 130, and may or may not employ the same radio access technology as the RAN 120a, the RAN 120b or both. The core network 130 may also serve as a gateway access between (i) the RANS 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. The PSTN 140 may include circuit switched telephone networks for providing plain old telephone service (POTS). The Internet 150 may include a network of computers and subnets (intranets) or both, and incorporate protocols, such as Internet Protocol (IP), Transmission Control Protocol (TCP), User Datagram Protocol (UDP). The EDs 110a 110b, and 110c may be multimode devices capable of operation according to multiple radio access technologies, and incorporate multiple transceivers necessary to support such.

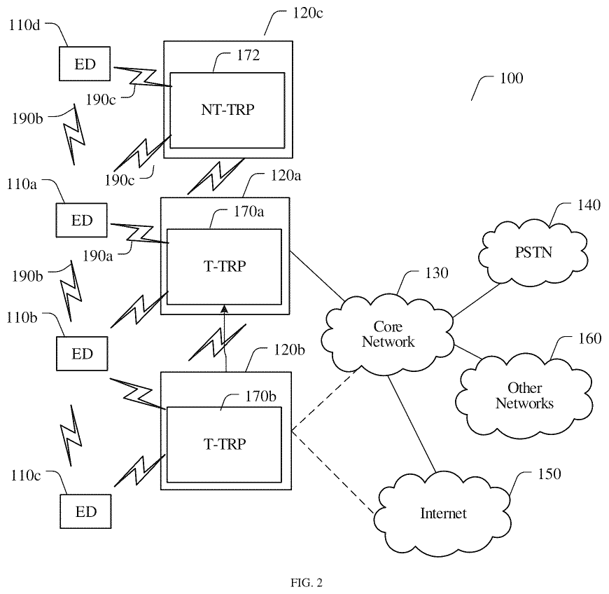

FIG. 3 illustrates another example of an ED and a base station. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronic device, a smart book, a vehicle, a car, a truck, a bus, a train, or an IOT device, an industrial device, or an apparatus (e.g. a communication module, a modem, or a chip) in the foregoing devices, among other possibilities. Future generation EDs 110 may be referred to using other terms. The base stations 170a and 170b are T-TRPs and will hereafter be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated, or enabled), turned-off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to output or modulate data or other content for transmission by at least one antenna 204 or interface. The transceiver is further configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The transceiver may also be known as an interface, for inputting and outputting operations.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or T-TRP 170. In some embodiments, the processor 276 implements the transmit beamforming and/or receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in the memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatuses (e.g. a communication module, a modem, or a chip) in the foregoing devices.

The CU (or CU-control plane (CP) and CU-user plane (UP)), DU or RU may be known by other names in some embodiments. For example, in an open RAN (ORAN) system, the CU may also be referred to as open CU (O-CU), the DU may also be referred to as open DU (O-DU), the CU-CP may also be referred to open CU-CP (O-CU-CP), the CU-UP may also be referred to as open CU-UP (O-CU-CP), and the RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

Embodiments of this application can be applied to any communication scenario where one or more transmitting apparatuses communicate with one or more receiving apparatuses. In a first example, the transmitting apparatus may be a network device (e.g. T-TRP or NT-TRP) or a chip in the network device, and the receiving apparatus may be a terminal device (e.g. ED) or a chip in the terminal device. In a second example, the transmitting apparatus may be a network device or a chip in the network device, and the receiving apparatus may be another network device or a chip in the network device. In a third example, the transmitting apparatus may be a terminal device or a chip in the terminal device, and the receiving apparatus may be another terminal device or a chip in the terminal device. This is not limited in this application. The following embodiments are illustrative of one transmitting apparatus and one receiving apparatus.

For ease of understanding the embodiments of this application, the terms involved in this application are briefly explained below.

### 1. WU Procedure

The WU procedure allows a node (which is an example of the receiving apparatus) to transition from a first mode to a second mode, where power consumption of the node in the first mode is less than that of the node in the second mode. For example, a node may turn off some circuitry (that is, the node transitions into the first mode) to reduce the power consumption when the node has no data to receive from or send to other nodes. The node can turn on the circuitry (that is, the node transitions from the first mode to the second mode) when the node has data to receive from other nodes. The node in the first mode does not know that it has data to receive, and a WU procedure is necessary for the node to transition from the first mode to the second mode. The transition of the node from the first mode to the second mode can also be referred to as the node being woken up.

For example, a transmitting apparatus may transmit a wake-up signal (WUS) to a receiving apparatus, to make the receiving apparatus transition from the first mode to the second mode. In some embodiments of this application, the first mode may be an idle mode (or state), an inactive mode (or state), or other low-power consumption modes. The second mode may be a connected mode (or state) or other modes with higher power consumption than the first mode.

It should be noted that, in the description of this application, “mode” and “state” can have the same meaning. This will not be repeated below.

In some embodiments of this application, the WU procedure may be a part of other procedures. For example, the receiving apparatus may receive the WUS as a part of a paging procedure; or the receiving apparatus may receive the WUS as a part of a procedure to request a sensing operation; or the receiving apparatus may receive the WUS as a part of a paging procedure to request a measurement; or the receiving apparatus may receive the WUS as a part of a specific non-periodic procedure.

The above WU procedure is only illustrative, and this is not limited in this application.

### 2. Pool of WUSs

In order for a transmitting apparatus to provide WU service for multiple receiving apparatuses, a pool of WUSs can be designed. The pool of WUSs can provide multiple WUSs with different parameters, and the multiple WUSs can be associated with identities of different nodes separately, so that different nodes use different WUSs for a WU procedure. For example, when the transmitting apparatus needs to wake up a receiving apparatus denoted by Node 1, the transmitting apparatus can transmit the WUS associated with the identity of Node 1. If Node 1 receives the WUS, it can be woken up. Furthermore, even if other nodes except for Node 1 receive the WUS, they will not be woken up.

In order to serve a large number of nodes, the pool of WUSs can be expanded by adding more possible WUSs. For example, the WUSs can be constructed with more time resources and/or frequency resources (i.e. time-frequency resources). However, if new time-frequency resources are used to construct the newly added WUSs, such an expansion may increase the WU resource overhead which is not desired. In addition, if overlapping time-frequency resources, which have been already used by WUSs in the pool, are used for the newly added WUSs, such an expansion can degrade the WU procedure performance by increasing WU false alarm probability.

To sum up, expanding the pool of WUSs may increase resource overhead which is not desired and/or degrade the WU procedure performance by increasing WU false alarm probability. Therefore, how to provide WU service for a large number of nodes without performance degradation or resource overhead becomes an urgent problem to be solved.

Therefore, this application provides a communication method in which at least one parameter of the WUS is associated with a location identifier, so that one or more of receiving apparatuses (nodes) associated with the location identifier can use the same WUS for a WU procedure. In other words, WUSs in the pool of WUSs can be used by more nodes without adding new WUSs. Thus, the WU procedure can be provided for a large number of nodes without performance degradation or resource overhead. In the following, the communication method provided in this application will be described in combination with FIG. 4.

FIG. 4 is a schematic flowchart of a communication method 400 according to an embodiment of this application. The communication method 400 may be applied to the communications system described above.

At S410, the transmitting apparatus transmits a wake-up signal. Correspondingly, the receiving apparatus, in a first mode, receives the wake-up signal.

The wake-up signal (WUS) may have one or more parameters and at least one parameter of the WUS is associated with a location identifier. The location identifier is used to indicate a location of a receiving apparatus.

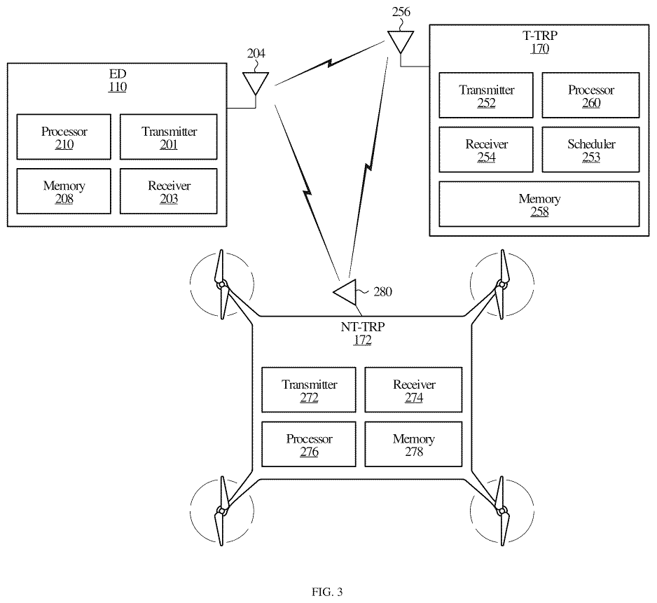

In some embodiments of this application, the WUS may be generated based on linear frequency modulation (LFM). One LFM signal is a signal whose frequency is a linear function of time with a slope. The LFM signal can be also named as a chirp signal. FIG. 5 is a schematic diagram of one LFM signal. As shown in FIG. 5, an initial time of the LFM signal is denoted by “t”, a time duration of the LFM signal is denoted by “T”, an ending time of the LFM signal is denoted by “t+T”, an initial frequency (which may also be called frequency hopping) of the LFM signal is denoted by “ƒ₀”, an LFM rate of the LFM signal is denoted by “α”, and an ending frequency of the LFM signal is denoted by “ƒ₀+αT”. The LFM rate of the LFM signal is the slope of the linear function. The LFM rate of the LFM signal can also be called a chirp rate or a chirp slope.

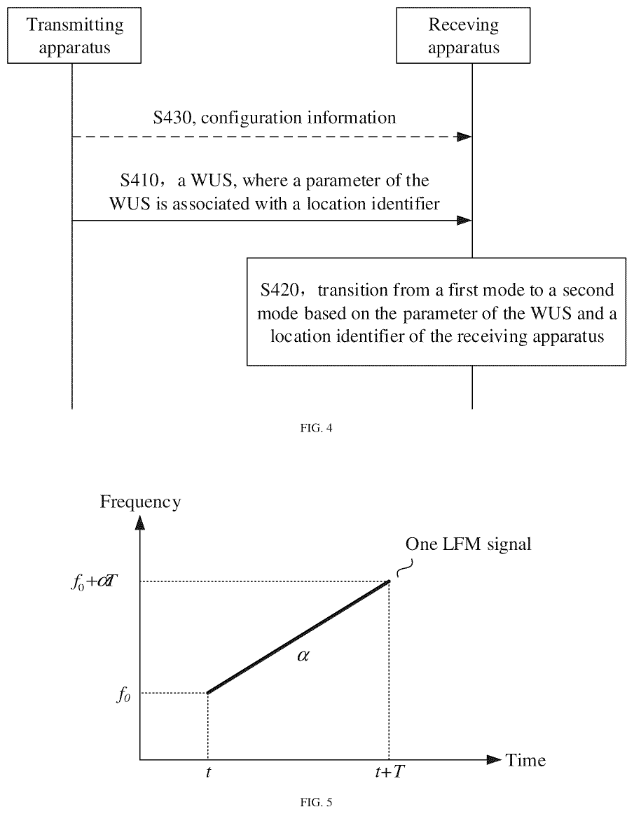

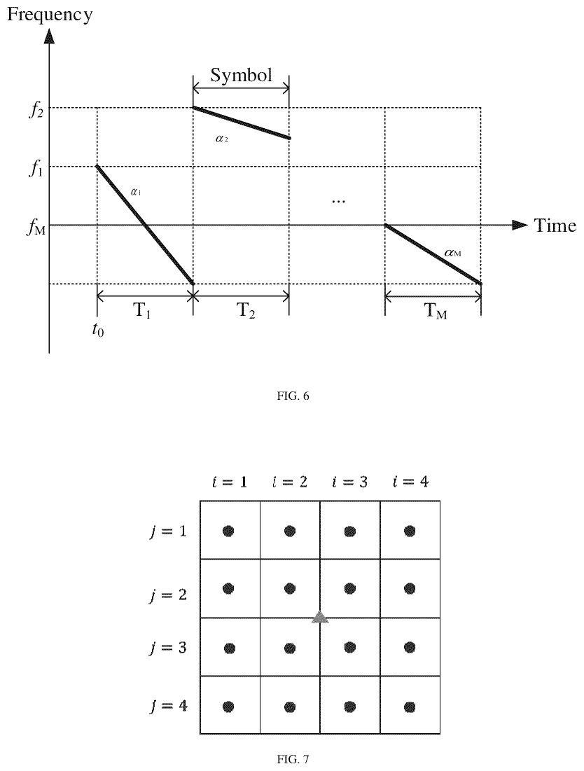

The WUS including at least one LFM signal can be referred to as an LFM-based signal. FIG. 6 is a schematic diagram of an LFM-based signal. As shown in FIG. 6, the LFM-based signal can include one or more LFM signals. The LFM-based signal may be indicated by one or more parameters, where the one or more parameters may be used to determine a position of the LFM-based signal in a time domain and a frequency domain. Based on the linear properties of the LFM signal, the one or more parameters may be a variety of parameter combinations that can determine the LFM-based signal.

For example, the parameter of the LFM-based signal may include at least one or more of the following: the number of symbols in the WUS denoted by M, where each of which includes one LFM signal; a sequence of LFM rates denoted by [symbol] =(α₁, α₂, . . . , α_{M}), where αᵢ is an LFM rate of the LFM signal in the i-th symbol of the WUS; a sequence of initial frequencies denoted by [symbol] =(ƒ₁, ƒ₂, . . . , ƒ_{M}), where ƒᵢ is an initial frequency of the LFM signal in the i-th symbol of the WUS; a sequence of time durations denoted by [symbol] =(T₁, T₂, . . . , T_{M}), where Tᵢ is a time duration of the LFM signal in the i-th symbol of the WUS; and an initial time of the WUS denoted by t₀.

Designing the WUS based on LFM signals can reduce the processing complexity and power consumption of the receiving apparatus compared with the WUS based on some other types of signals.

In some other embodiments of this application, the WUS may be generated based on a Zadoff-Chu (ZC) sequence. The ZC sequence is a sequence having a fixed cyclic cross-correlation and zero cyclic auto-correlation properties. For example, a ZC sequence can be represented by sequence x_{q}=(x_{q}[0], x_{q}[1], . . . , x_{q}[N_{zc}−1]) with:

$${x}_{q} [ n ] = {e}^{- j π q \frac{n ( n + 1 )}{{N}_{z c}}} ,$$

n ∈ {1, 2, . . . , N_{zc}}, where x_{q} is the ZC sequence, x_{q}[n] is the element in the ZC sequence, q is the root of the ZC sequence, and N_{zc} is the length of the ZC sequence. Furthermore, the ZC sequence can be cyclically shifted to get

$${x}_{q}^{( m )} [ n ] = {x}_{q} [ ( n + m ) mod {N}_{z c} ] ,$$

where m is the cyclic shift value of the ZC sequence, and m is an integer.

The WUS including a ZC sequence can be referred to as an ZC-based signal. The parameter of the ZC-based signal may include at least one or more of the following: a root of the ZC sequence denoted by q, a length of the ZC sequence denoted by N_{zc}, and a cyclic shift value of the ZC sequence denoted by m.

The LFM as well as ZC sequence have a constant amplitude, i.e. 0 dB peak to average power ratio (PAPR). Thus, designing the WUS based on LFM or a ZC sequence has an advantage in terms of power efficiency and hardware. Furthermore, due to the fixed cyclic cross-correlation and zero cyclic auto-correlation properties of the ZC sequence, ZC-based signal can be used in applications where there is a detection task such as WUS detection.

The WUS may be generated based on other types of signals and/or sequences, and this is not limited in this application.

For example, the WUS may be generated based on a pseudo-noise (PN) sequence, which is also known as a pseudo-random-noise (PRN) sequence, a pseudo random binary sequence (PRBS), a linear feedback shift register (LFSR) sequence. The PN sequence is typically generated using an LFSR including a number of shift registers and a feedback logic which is typically implemented by logical operations such as exclusive OR (XOR). Given an LSFR, the initial state of the shift registers can produce various PN sequences. The parameter of the PN-based signal may include all possible initial states of the shift registers in the LFSR.

For another example, the WUS may be generated based on a maximal sequence, which is also known as an m-sequence. The m-sequence is a special case of PN sequence where the LFSR is maximal.

For another example, the WUS may be generated based on a Gold sequence. The Gold sequence is the result of element-by-element XOR of two m-sequences with the same length.

The parameter(s) of the WUS can be denoted by a set [symbol] , and at least one parameter in the set [symbol] can be associated with the location identifier. For example, if the WUS is an LFM-based signal, the set can be represented by [symbol] and at least one among [symbol] and t₀ can be associated with the location identifier. For another example, if the WUS is a ZC-based signal, the set can be represented by [symbol] ={q, N_{zc}, m}, and at least one among q, N_{zc} and m can be associated with the location identifier. For the WUS based on other signals and/or sequences, the set [symbol] can also be represented by parameter(s) corresponding to the other signals and/or sequences. For example, if the WUS is generated based on the PN sequence, then the set [symbol] can be represented by the set of all possible initial states of the shift registers in the LFSR; if the WUS is generated based on the m-sequence, then the set [symbol] can be represented by the set of all possible initial states of the shift registers in the LFSR; if the WUS is generated based on the Gold sequence, then the set [symbol] can be represented by the set of all possible initial states of the shift registers in the LFSRs generating the two m-sequences used in generation of the Gold sequence.

It should be understood that the number of parameters associated with a location identifier can be equal to or greater than one. For ease of description, “a parameter associated with the location identifier” or “the parameter associated with the location identifier” may be used as an example in the following description but does not limit the scope of protection of the embodiments of this application, and this will not be repeated below.

In some embodiments of this application, the location identifier may include an exact coordinate of a receiving apparatus in a rectangular coordinate system (also known as a Cartesian coordinate system). For example, the location identifier can include a coordinate of the location of a receiving apparatus in a two-dimensional coordinate system with a reference point as an origin. For another example, the location identifier can include a coordinate of the location of a receiving apparatus in a three-dimensional coordinate system with a reference point as an origin.

In some embodiments of this application, the location identifier may include a coarse approximation of the location of a receiving apparatus in a rectangular coordinate system. For example, a grid of points in the three-dimensional space can be used, and the location identifier can indicate the closest grid point to the location of a receiving apparatus in the three-dimensional space. For another example, a grid of points in the two-dimensional space can be used, and the location identifier can indicate the closest grid point to the location of a receiving apparatus in the two-dimensional space.

FIG. 7 illustrates an example of a location identifier indicating a coarse approximation of a location of a receiving apparatus in a two-dimensional space. As shown in FIG. 7, the two-dimensional space is divided into a 4 by 4 grid. Each grid point, shown by a dot in the middle of a square in FIG. 7, represents every location within that square. This creates 16 location regions (LRs), i.e. 16 squares in FIG. 7. For a receiving apparatus located in any LR, the closest grid point to this receiving apparatus is the point in the middle of this LR, so an identifier of the LR, where the receiving apparatus is located in, can be used as the location identifier of the receiving apparatus. For example, the pair (i, j), i, j ∈ {1,2,3,4}, can be the identifier of the LR, which is used as the location identifier.

It should be understood that the above LRs divided and represented method are only examples for illustration, but do not limit the scope of protection of the embodiments of this application.

In some embodiments of this application, the location identifier may include an exact coordinate of a receiving apparatus in a polar coordinate system. For example, the location identifier may include an angular direction, which is defined as the angle between the location of the receiving apparatus and a reference point measured with respect to a reference direction. FIG. 8 illustrates an example of an angular direction. As shown in FIG. 8, the dashed line represents the reference direction passing through the reference point. The solid line represents the direction of the location of the receiving apparatus with respect to the reference point. The angle between the dashed line and the solid line can be the angular direction of the receiving apparatus, which is denoted by θ.

In some embodiments of this application, the location identifier may include a coarse approximation of the location of a receiving apparatus in a polar coordinate system. For example, an identifier of an angular region (AR), where the receiving apparatus is located in, can be used as the location identifier of the receiving apparatus. The angular region is a region between a first direction and a second direction with respect to a reference point.

FIG. 9 illustrates an example of a location identifier indicating a coarse approximation of an angular direction of a receiving apparatus. As shown in FIG. 9, the two-dimensional space is divided into a grid with four directions (d=1, 2, 3, 4). The four grid directions are respectively located in four ARs, which are shown by different patterns, and each grid direction represents every location within its own AR. For a receiving apparatus located in any AR, the closest direction to this receiving apparatus is the grid direction in this LR, so an identifier of the AR, where the receiving apparatus is located in, can be used as the location identifier of the receiving apparatus. For example, d ∈ {1,2,3,4}, can be the identifier of the AR, which is used as the location identifier.

It should be understood that the above ARs divided and represented method are only examples for illustration, but do not limit the scope of protection of the embodiments of this application.

In some embodiments of this application, the parameter of the WUS can also be associated with an identity of the receiving apparatus. For example, if multiple receiving apparatuses have the same location identifier (for example, located in the same LR), they will be assigned orthogonal or semi-orthogonal WUSs. Thus, different receiving apparatuses associated with the same location identifier can use different configurations of the WUS.

Each receiving apparatus that can be woken up by the transmitting apparatus is associated with a set of configuration parameters which can define a WUS (also can be referred to as a WUS configuration), and one or more configuration parameters among the set are associated with the location identifier of the receiving apparatus. When the transmitting apparatus needs to wake up a target receiving apparatus, the transmitting apparatus may generate a WUS based on the configuration parameter(s) of the target receiving apparatus. That is, the transmitting apparatus uses the WUS configuration associated with the receiving apparatus that needs to be woken up as the parameter(s) of the WUS.

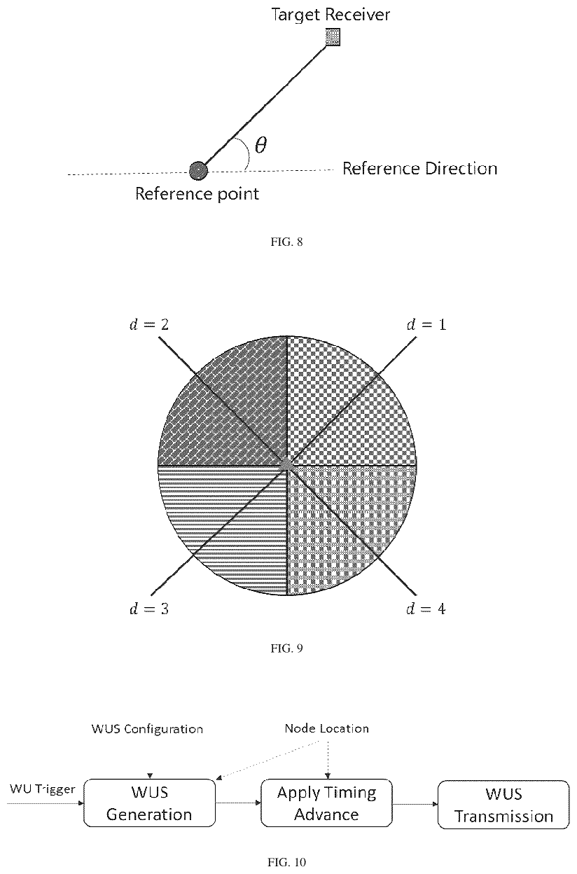

FIG. 10 illustrates an example of a WU procedure at a transmitting apparatus side. As shown in FIG. 10, whenever there is a trigger for WU, the WUS is generated based on the WUS configuration of the target receiving apparatus which is to be woken up, where one or more parameters of the WUS are determined based on the location identifier of the target receiving apparatus and possibly an identity of the target receiving apparatus. Optionally, a timing advance (TA) can be applied on the WUS. Applying the TA makes the receiving apparatuses separated in the TA domain, which will be illustrated specifically in following embodiments, which is not be repeated here. Then, the WUS can be transmitted to the target receiving apparatus.

In some embodiments of this application, the transmitting apparatus may obtain the configuration parameter associated with the location identifier of the target receiving apparatus based on a mapping function. The input of the mapping function may include a location identifier, and the output of the mapping function may include a configuration parameter. For example, the mapping function can be represented as WUSₖ=ƒ(pₖ), where ƒ(pₖ) is the mapping function, pₖ is the location identifier of a receiving apparatus denoted by node k. Thus, the transmitting apparatus can input the location identifier of the target receiving apparatus into the mapping function, and obtain the WUS configuration of the target receiving apparatus as output. Thus, the WUS generated based on this WUS configuration may be used to wake up all receiving apparatuses in a certain region which have the same location identifier.

In some embodiments, the WUS configuration is a function of the location region (LR) index. This configuration may be intended for waking up all the WUS receivers within a certain LR. As an example, in FIG. 7, one WUS configuration is assigned to each of the 16 LRs. For illustration, consider LFM-based WUS and assume that WUS has four symbols (M=4) and define L=16 possible configurations. Configuration l ∈ {1,2, . . . ,16} is defined by 1) rate sequence (αₗ,-αₗ, αₗ,-αₗ),2) initial frequencies (ƒₗ, ƒₗ, ƒₗ, ƒₗ), 3) time durations (T_{sym}, T_{sym}, T_{sym}, T_{sym}), where T_{sym} is the symbol time duration, and 4) t₀=0. Configuration l=4(j−1)+i is assigned to the LR represented by pair (i, j) in FIG. 7. Assuming that WUS transmitter intends to send the WUS associated with LR represented by pair (i′, j′), the Configuration l′=4 (j′−1)+i′ is used at the WUS transmitter. Upon reception, the WUS receiver processes and finds an estimate of [symbol] denoted by [symbol] Subsequently, the WUS receiver can find an estimate of LR indices, denoted by ( [symbol] ), with which the WUS configurations are associated. In this example, the associations are [symbol] =[\hat{l}′/4]+1, and [symbol] =\hat{l}′−4( [symbol] −1). Accordingly, the WUS receiver can determine if it is located in LR ( [symbol] ) and then wake up or remain in the low power mode. One advantage of this embodiment is the ability to wake up all the WUS receivers located in a certain LR in the network with minimum overhead. Information such as the WUS configurations, the LR indices ( [symbol] ), and the mapping formulas (e.g., l′=4 (j′−1)+i′, [symbol] =[\hat{l}′/4]+1, and [symbol] =\hat{l}′−4( [symbol] −1)) can be signaled to the WUS receiver before entering the low power mode. The signaling used may be radio resource control (RRC) signaling, media access control, control element, signaling (MAC-CE), or other signaling methods. While an LFM-based WUS is illustrated in this example embodiment, other types of WUS such as ZC-based WUS, PN-based WUS, m-sequence-based WUS, and Gold sequence-based WUS, can also be used in a similar manner. Moreover, the same method can be applied to the case where the network is divided into angular regions (ARs) or a combination of LRs and ARs.

Optionally, the input of the mapping function may also include an identity of a receiving apparatus. For example, the mapping function can be represented as WUSₖ=ƒ(pₖ, IDₖ), where ƒ(PK, IDₖ) is the mapping function, pₖ is the location identifier of a receiving apparatus denoted by node k, IDₖ is the identity of node k, and WUSₖ is the WUS configuration of node k. Thus, the transmitting apparatus can input the location identifier of the target receiving apparatus and possibly an identity of the target receiving apparatus into the mapping function, and obtain the WUS configuration of the target receiving apparatus as output.

At S420, the receiving apparatus transitions from the first mode to a second mode based on the parameter of the WUS and a location identifier of the receiving apparatus.

The receiving apparatus may determine whether the captured WUS matches the WUS configuration which is associated with its location identifier. For example, if the parameter of the captured WUS matches the configuration parameter(s) associated with the location identifier of the receiving apparatus, the receiving apparatus determines to transition from a first mode to a second mode, that is, the receiving apparatus determines to wake up. If the parameter of the captured WUS does not match the configuration parameter(s) associated with the location identifier of the receiving apparatus, the receiving apparatus determines to stay in the first mode, that is, the receiving apparatus determines not to wake up.

In some embodiments, the receiving apparatus may obtain the configuration parameter of the WUS based on a mapping function, where the input of the mapping function includes a location identifier and possibly an identity of the receiving apparatus, and the output of the mapping function includes a configuration parameter. The receiving apparatus may input its location identifier and possibly its identity into the mapping function, and obtain the configuration parameter of the WUS as output. Then, the receiving apparatus can perform WUS detection based on the configuration parameter of the WUS and decide if its own WUS is present or not.

In some embodiments, the mapping function can be obtained from configuration information which is transmitted by the transmitting apparatus.

In some embodiments, a WUS configuration may be re-used by multiple receiving apparatuses with different location identifiers.

For example, a set of WUS configurations may be denoted by [symbol] . Each member of the set C can represent a possible WUS configuration and different members of the set C are orthogonal or semi-orthogonal, so that the correlation between WUSs using different members of the set C is zero or a relatively small value. To re-use members of the set C, the set C can be divided into multiple mutually exclusive subsets denoted by [symbol] . Furthermore, each location identifier can be associated with one subset among [symbol] , and the receiving apparatus associated with the location identifier can only use the WUS configuration in the subset associated with this location identifier.

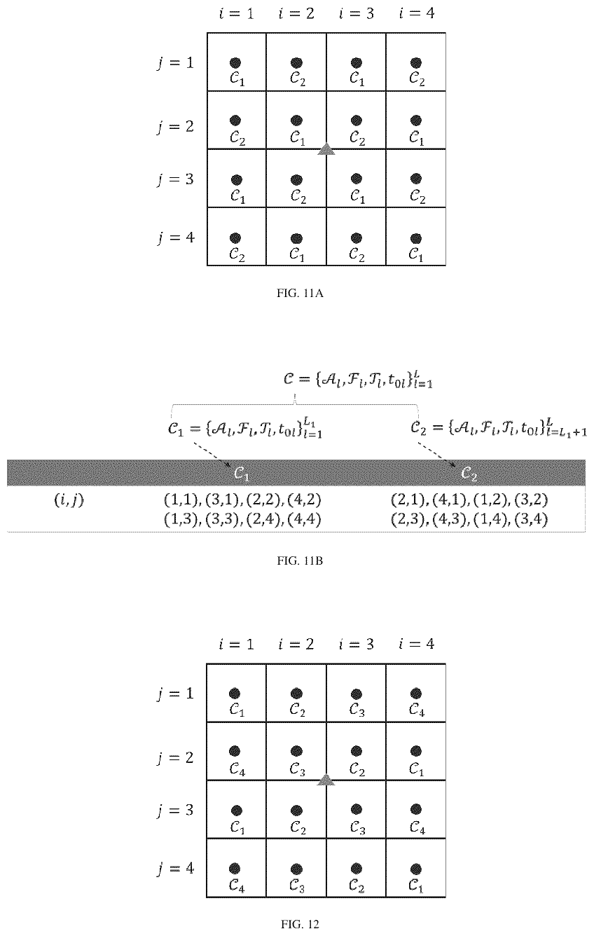

FIG. 11A, FIG. 11B and FIG. 12 illustrate examples of re-using a WUS configuration in different LRs and FIG. 13 illustrates an example of re-using a WUS configuration in different ARs. As shown in FIG. 11A, the set [symbol] is divided into two subsets [symbol] and [symbol] , and each subset is used by 8 LRs among 16 LRs, so the re-use factor in the example of FIG. 11A is 0.5. As shown in FIG. 12, the set [symbol] is divided into four subsets [symbol] , and [symbol] and each subset is used by 4 LRs among 16 LRs, so the re-use factor in the example of FIG. 12 is 0.25. As shown in FIG. 13, the set [symbol] is divided into two subsets [symbol] and [symbol] , and each subset is used by 2 ARs among 4 ARs, so the re-use factor in the example of FIG. 13 is 0.5.

FIG. 11B illustrates a further example based on FIG. 11A in which the LFM-based WUS is used and there are L possible WUS configurations. The set of all configurations is denoted by

$$𝒞 = {\{ {𝒜}_{l} , {ℱ}_{l} , {𝒯}_{l} , {t}_{0 l} \}}_{l = 1}^{L} .$$

In the example of FIG. 11A, the re-use factor is 0.5, which divides set [symbol] into two subsets

$${𝒞}_{1} = {\{ {𝒜}_{l} , {ℱ}_{l} , {𝒯}_{l} , {t}_{0 l} \}}_{l = 1}^{{L}_{1}} and {𝒞}_{2} {\{ {𝒜}_{l} , {ℱ}_{l} , {𝒯}_{l} , {t}_{0 l} \}}_{l = {L}_{1} + 1}^{L}$$

that are mutually exclusive as shown in FIG. 11B.

Continuing the re-use example, each LR in the region is associated with either of [symbol] or [symbol] according to FIGS. 11A and 11B. In a first option for choosing a configuration, one WUS configuration is chosen for each WUS receiver per each location region (LR) from the subset of configurations associated with that LR. Considering FIG. 11A, for example, each WUS receiver is assigned 16 WUS configurations, one for each LR. The WUS configuration chosen for a WUS receiver in a specific LR can be randomly chosen or non-randomly chosen. In the case of random selection, given an LR, a random index from the subset of configuration indices associated with that LR ( [symbol] or [symbol] in this example) is selected for the WUS receiver by the network. The seed of the random index generator may or may not be a function of receiver identity (ID). In the non-random method, the network can select a WUS configuration for each WUS receiver per LR using an algorithm or formula which may or may not use receiver ID. In this option, a table including all the indices (each from 1 to L or from 0 to L−1) of WUS configurations chosen for a WUS receiver is sent to that WUS receiver prior to entering a low power mode; the table may be sent using signaling such as RRC, MAC-CE, or another signaling. Assuming L=128 and L₁=64, an example of such a table for a WUS receiver is shown in Table 1 below. The values inside the table represent the index of a WUS configuration assigned to the receiver in each LR. Additionally, if the selection is non-random, for instance based on a formula as a function of receiver ID, the parameters of the formula can be broadcasted to all receivers before entering a low power mode so that the receiver can obtain its WUS configuration in every LR.

TABLE 1

i

| j | 1 | 2 | 3 | 4 |
|---|---|---|---|---|
| 1 | 4 | 98 | 25 | 69 |
| 2 | 83 | 45 | 101 | 3 |
| 3 | 21 | 86 | 23 | 93 |
| 4 | 120 | 37 | 114 | 61 |

In a second option for choosing a configuration, one WUS configuration is chosen for each WUS receiver per [symbol] . For example, in the case of re-use factor 0.5 as in FIGS. 11A and 11B, the set of configurations includes two subsets of configuration indices [symbol] and [symbol] . For each WUS receiver, the network selects two WUS configurations, one for [symbol] and one for [symbol] . If the WUS receiver is in a LR associated with [symbol] , the receiver uses the WUS configuration selected from [symbol] . Similarly, if the WUS receiver is in a LR associated with [symbol] , the receiver uses the WUS configuration selected from [symbol] . Selection of WUS configuration can be random or non-random and may or may not depend on the WUS receiver ID. In this option, a table including all the indices (each from 1 to L or from 0 to L−1) of WUS configurations chosen for a WUS receiver is sent to that WUS receiver prior to entering a low power mode; the table may be sent using signaling such as RRC, MAC-CE, or another signaling. Assuming L=128 in FIGS. 11A and 11B (re-use factor 0.5), an example of such a table for a WUS receiver is shown in Table 2 below. Additionally, if the selection is non-random, for instance based on a formula as a function of receiver ID, the parameters of the formula can be broadcasted to all receivers before entering a low power mode so that the receiver can obtain its WUS configuration in every LR.

TABLE 2

| [symbol] | [symbol] | [symbol] |
|---|---|---|
| WUS Configuration Index | 22 | 76 |

While the preceding examples illustrate an LFM-based WUS, other types of WUS such as ZC-based WUS, PN-based WUS, m-sequence-based WUS, and Gold sequence-based WUS, can also be used in a similar manner. Moreover, the same method can be applied to the case where the network is divided into angular regions (ARs) or a combination of LRs and ARs.

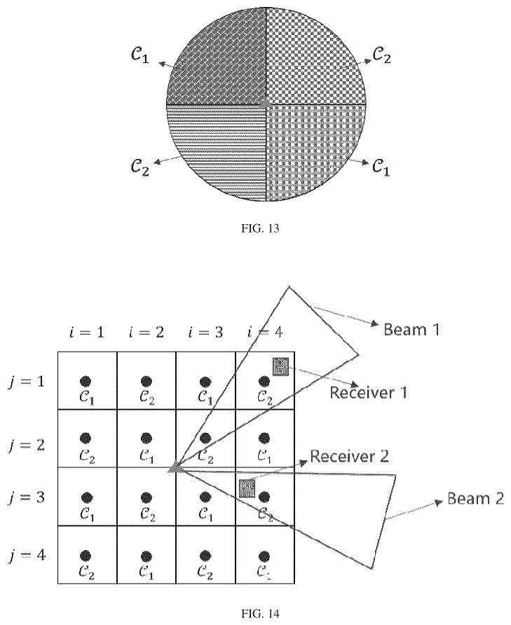

In order not to increase WU false alarm probability, different LRs or ARs using the same WUS configuration may be separated in other domains. For ease of understanding the embodiments of this application, five examples of re-using a WUS configuration are illustrated in combination with FIGS. 14-19.

In some embodiments, WUSs having the same parameter can be separated by being transmitted with different beams. That is, the WUS can be transmitted with a first beam among multiple beams, where the multiple beams cover different locations and the first beam covers the location of the receiving apparatus.

In a first example, as shown in FIG. 14, two receiving apparatuses denoted by Receiver 1 and Receiver 2. Receive 1 is located in the LR represented by i=4 and j=1 associated with subset [symbol] . Receive 2 is located in the LR represented by i=4 and j=3 associated with subset [symbol] . Receiver 1 and Receiver 2 use the same WUS configuration. That is, when the transmitting apparatus transmits a WUS intending to wake up Receiver 1, Receiver 2 may also be woken up if it can successfully detect the transmitted WUS. However, in the embodiments of this application, Receiver 1 and Receiver 2 can be served with different beams to avoid the above problem. For example, when the transmitting apparatus intends to wake up Receiver 1, it may use a beam denoted by Beam 1 to transmit the WUS. Since Beam 1 covers the location of Receiver 1 but not Receiver 2, Receiver 2 will not receive the WUS or will only receive a weak version of the WUS which reduces the detection probability. This way, Receiver 1 can receive the WUS successfully without causing a false alarm for Receiver 2.

The above embodiments can also be applied to situations where the location identifier is an identifier of AR.

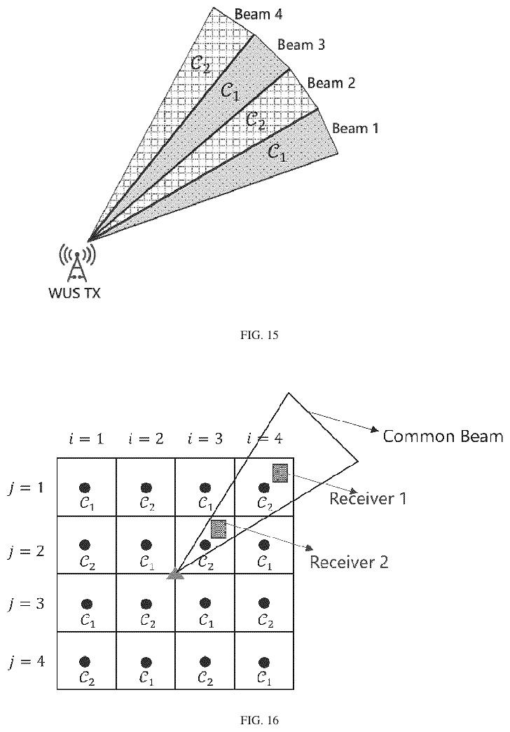

In a second example, as shown in FIG. 15, the transmitting apparatus may use four beams to cover a part of the network, and each beam serves the receiving apparatuses within a single AR. Thus, non-adjacent ARs can use the same subset. For example, AR 1, which is served by Beam 1, and AR 3, which is served by Beam 3, can be associated with the same subset [symbol] .

In some embodiments, WUSs having the same parameter can be separated by applying different timing advances (TAs) at the transmitting apparatus. That is, the WUS can be transmitted with a TA, where the TA is associated with a distance between the target receiving apparatus and the transmitting apparatus. If the transmitting apparatus applies the TA when transmitting the WUS, the receiving apparatus can obtain an estimated range based on the WUS and determines whether to be woken up based on the estimated range, where the estimated range is associated with the timing advance and the distance between the receiving apparatus and the transmitting apparatus.

In a third example, as shown in FIG. 16, two receiving apparatuses denoted by Receiver 1 and Receiver 2. Receive 1 is located in the LR represented by i=4 and j=1 associated with subset [symbol] . Receive 2 is located in the LR represented by i=3 and j=2 associated with subset [symbol] . Receiver 1 and Receiver 2 use the same WUS configuration and are covered by a common beam. That is, when the transmitting apparatus transmits a WUS intending to wake up Receiver 1, Receiver 2 may also be woken up. In this case, in the embodiments of this application, the transmitting apparatus can apply different TAs for Receiver 1 and Receiver 2 to avoid the above problem. If a TA is applied to the WUS, the receiving apparatus can estimate its range from the transmitting apparatus, which is referred to as the estimated range, by processing the received WUS. The estimated range is associated with the timing advance and the real distance between the receiving apparatus and the transmitting apparatus, which may be represented as dₑₛ=|d−d_{TA}|, where dₑₛ is the estimated range, d is the real distance between the receiving apparatus and the transmitting apparatus, and d_{TA} is the distance corresponding to the applied TA. Specifically, d_{TA} can be represented as d_{TA}=T×c, where T is the applied TA and c is the light velocity. For example, when the transmitting apparatus intends to wake up Receiver 1, it may apply a TA before transmitting the WUS to ensure that Receiver 1 obtains an estimated range less than a first threshold (the first threshold may be close to zero). Since the real distance from the transmitting apparatus to Receiver 2 is different from Receiver 1, Receiver 2 will obtain an estimated range greater than the first threshold or the WUS will not even be received by the measurement window of the Receiver 2 due to the TA which reduces the detection probability. In this way, Receiver 1 can receive the WUS successfully without causing a false alarm for Receiver 2. Optionally, the value of the first threshold can also be signaled to the receiving apparatus as a part of the WUS configuration.

FIG. 17 illustrates a more detailed explanation of the third example. If the transmitting apparatus intends to wake up Receiver 1 (i.e. UE 1 shown in FIG. 17), it may apply a TA to ensure that Receiver 1 obtains an estimated range close to zero. That is, the value of d_{TA} is close to d₁, where d₁ is the real distance between the transmitting apparatus and Receiver 1. In this case, Receiver 2 (i.e. UE 2 shown in FIG. 17) will obtain an estimated range close to (d₂−d₁), where d₂ is the real distance between the transmitting apparatus and Receiver 2. Thus, applying TA at the transmitting apparatus can separate Receiver 1 and Receiver 2 since they are in different distances from the transmitting apparatus and have different TAs.

The above embodiments can also be used in combination.

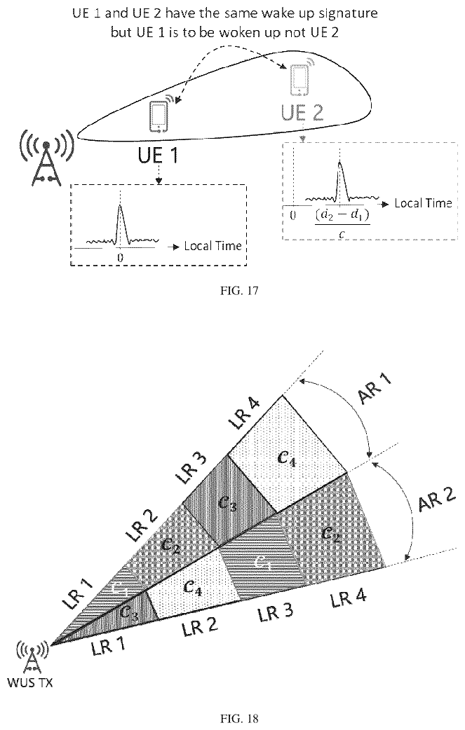

In a fourth example, as shown in FIG. 18, the space can be divided into 8 sub-regions (SRs) by four LRs and two ARs. Each SR can be associated with one subset, and are receiving apparatus associated within the SR can only use the WUS configuration in the subset associated with this SR. Thus, if two receiving apparatuses are located within the same SR, they will be assigned orthogonal or semi-orthogonal WUS configurations. Furthermore, different SRs can re-use the same WUS configuration. For example, if two receiving apparatuses are located in different ARs, such receiving apparatuses can be served with different beams. Hence, they can use the same WUS configuration without increasing the false alarm probability. For another example, if two receiving apparatuses are located within the same AR but in different SRs, they still can use the same WUS configuration by applying different TAs.

It should be noted that transmitting WUSs with different beams and/or TAs is only examples for illustration. WUSs having the same parameter can also be separated in other domains, which are not limited in this application. For example, the WUS can be transmitted with an intended depth, where the difference between the intended depth and a radial distance of the target receiving apparatus is less than a second threshold, and the radial distance of the target receiving apparatus is a distance between the target receiving apparatus and the transmitting apparatus. Thus, WUSs having the same parameter can be separated by being transmitted to different intended depths.

In a fifth example, as shown in FIG. 19, the transmitting apparatus may be equipped with an extremely large antenna array (ELAA) and the receiving apparatuses may be in the near-field coverage of the transmitting apparatus. In this case, the transmitting apparatus can transmit a signal to an intended depth, so that the signal can only be received by the receiving apparatus whose radial distance is close to the intended depth. The receiving apparatuses located at radial distances far from the intended depth may only receive a weak version of the WUS which reduces the detection probability. Thus, if receiving apparatuses are located at different radial distances from the transmitting apparatus, the transmitting apparatus can transmit the WUS to one of them without others being able to receive it. The advantage of transmitting the WUS with such an ELAA is the need for synchronization and/or applying TA can be relaxed because WUS detection is not performed based on timing measurements.

In some embodiments, before S410, the transmitting apparatus may indicate the receiving apparatus about the configurations of the WUS. That is, the transmitting apparatus and the receiving apparatus may perform the following at S430.

Optionally, at S430, the transmitting apparatus transmits configuration information to the receiving apparatus. Correspondingly, the receiving apparatus receives the configuration information from the transmitting apparatus.

The configuration information may indicate one or more configuration parameters of the WUS, and at least one configuration parameter of the WUS is associated with a location identifier of the receiving apparatus.

In some embodiments, the transmitting apparatus can transmit the first configuration information before the receiving apparatus enters into a first mode (a low power consumption mode).

In some embodiments, the configuration information may include a mapping function, the input of the mapping function may include a location identifier, and the output of the mapping function may include a configuration parameter.

In some embodiments, the configuration information may also indicate whether a TA will be applied in the WUS.

In some embodiments, the first configuration information can be carried in RRC or MAC-CE. For example, the transmitting apparatus may transmit the first information using RRC or MAC-CE signaling procedures.

In some embodiments, the WUS may include a prefix part which is used to obtain a timing offset of the WUS, and the parameter of the WUS is obtained based on the timing offset. In other words, the receiving apparatus may perform synchronization as a part of the WU procedure before WUS detection. Thus, the reliability of the WU procedure can be improved.

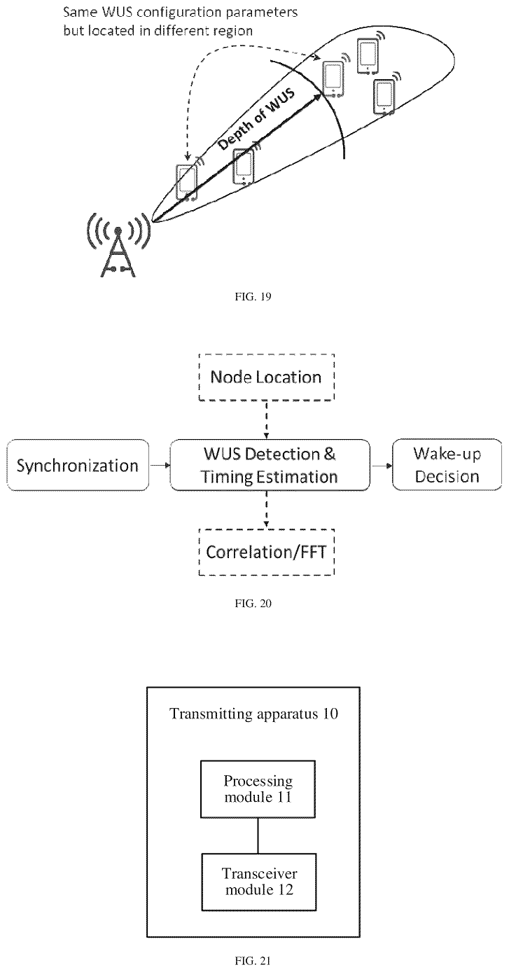

FIG. 20 illustrates an example of a WU procedure at a receiving apparatus side. As shown in FIG. 20, the receiving apparatus may perform WUS detection on the received signal based on its own WUS configuration. The WUS configuration may be obtained based on configuration information from the transmitting apparatus before entering into a first mode. Optionally, the receiving apparatus may perform synchronization before performing WUS detection. Since at least one parameter of the WUS is associated with the location identifier of the receiving apparatus, the receiving apparatus can perform WUS detection based on its location and determine if its own WUS is present or not. Additionally, the receiving apparatus can perform a timing measurement which can be used to obtain an estimated range. Such an estimated range can be used to make a decision for WU if the timing advance is applied at the transmitting apparatus. Eventually, the receiver can make a decision based on the detection result and possibly the estimated range.

In this application, at least one parameter of the WUS is associated with a location identifier, so that one or more of receiving apparatuses (nodes) associated with the location identifier can use the same WUS for the WU procedure. That is, WUSs in the pool of WUSs can be used by more nodes without adding new WUSs. Thus, the WU procedure can be provided for a large number of nodes without performance degradation or resource overhead.

The communication method according to the embodiments of this application is described in detail above with reference to FIG. 4 to FIG. 20, and the transmitting apparatus and the receiving apparatus according to the embodiments of this application will be described in detail below with reference to FIG. 21 to FIG. 25.

FIG. 21 is a schematic block diagram of a transmitting apparatus 10 according to an embodiment of this application. As shown in FIG. 21, the transmitting apparatus 10 includes:
a processing module 11, configured to generate a wake-up signal (WUS); and
a transceiver module 12, configured to transmit the WUS, where a parameter of the WUS is associated with a location identifier, the parameter of the WUS is used for a receiving apparatus to transition from a first mode to a second mode based on a location identifier of the receiving apparatus, and the location identifier of the receiving apparatus indicates a location of the receiving apparatus.

Therefore, one or more of receiving apparatuses (nodes) associated with the location identifier can use the same WUS for the WU procedure. In other words, WUSs in the pool of WUSs can be used by more nodes without adding new WUSs. Thus, the WU procedure can be provided for a large number of nodes without performance degradation or resource overhead.

The transmitting apparatus 10 in this embodiment of this application may correspond to the transmitting apparatus in the communication method in the embodiments of this application described above, and the foregoing management operations and/or functions and other management operations and/or functions of modules of the transmitting apparatus 10 are intended to implement corresponding steps of the foregoing methods. For brevity, details are not described herein again.

The transceiver module 12 in this embodiment of this application may be implemented by a transceiver, and the processing module 11 may be implemented by a processor.

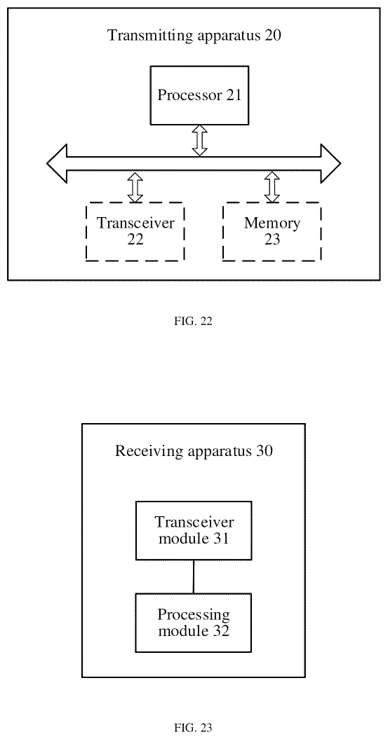

As shown in FIG. 22, a transmitting apparatus 20 may include a transceiver 22. Optionally, the transmitting apparatus 20 may further include a processor 21 and/or a memory 23. The memory 23 may be configured to store indication information, or may be configured to store code, instructions, and the like that is to be executed by the processor 21.

FIG. 23 is a schematic block diagram of a receiving apparatus 30 according to an embodiment of this application. As shown in FIG. 23, the receiving apparatus 30 includes:

a transceiver module 23, configured to receive, in a first mode, a wake-up signal (WUS), where a parameter of the WUS is associated with a location identifier; and

a processing module 32, configured to transition from the first mode to a second mode based on the parameter of the WUS and a location identifier of the receiving apparatus, where the location identifier of the receiving apparatus indicates a location of the receiving apparatus.

The receiving apparatus 30 in this embodiment of this application may correspond to the receiving apparatus in the communication method in the embodiments of this application described above, and the management operations and/or functions and other management operations and/or functions of modules of the receiving apparatus 30 are intended to implement corresponding steps of the foregoing methods. For brevity, details are not described herein again.

The transceiver module 31 in this embodiment of this application may be implemented by a transceiver, and the processing module 32 may be implemented by a processor.

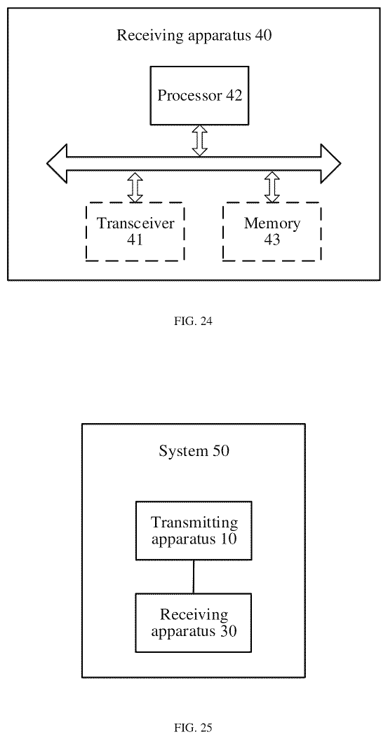

As shown in FIG. 24, a receiving apparatus 40 may include a transceiver 41.

Optionally, the receiving apparatus 40 may further include a processor 42 and/or a memory 43. The memory 43 may be configured to store indication information, or may be configured to store code, instructions, and the like that is to be executed by the processor 42.

The processor 21 or the processor 42 may be an integrated circuit chip and have a signal processing capability. In an embodiment process, steps in the foregoing method embodiments can be implemented by using a hardware-integrated logical circuit in the processor, or by using instructions in the form of software. The processing module 21 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or a transistor logic device, or a discrete hardware component. All methods, steps, and logical block diagrams disclosed in these embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

The memory 23 or the memory 43 in the embodiments of the present invention may be a volatile memory or a non-volatile memory, or may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

An embodiment of this application further provides a system. As shown in FIG. 25, a system 50 includes:

the transmitting apparatus 10 according to the embodiments of this application and the receiving apparatus 30 according to the embodiments of this application.

An embodiment of this application further provides a computer storage medium, and the computer storage medium may store a program instruction for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method performed by a receiving apparatus, comprising:
receiving, in a first mode, a wake-up signal (WUS), wherein a parameter of the WUS is associated with an associated location identifier; and
transitioning from the first mode to a second mode based on the parameter of the WUS and a location identifier of the receiving apparatus, wherein the location identifier of the receiving apparatus indicates a location of the receiving apparatus.

2. The method of claim 1, wherein the transitioning from the first mode to the second mode based on the parameter of the WUS and the location identifier of the receiving apparatus comprises:
obtaining a configuration parameter associated with the receiving apparatus based on a mapping function and the location identifier of the receiving apparatus, wherein an input of the mapping function comprises the location identifier of the receiving apparatus, and an output of the mapping function comprises the configuration parameter; and
transitioning from the first mode to the second mode based on the parameter of the WUS and the configuration parameter associated with the receiving apparatus.

3. The method of claim 1, wherein the WUS comprises a Zadoff-Chu (ZC) sequence, and the parameter of the WUS comprises at least one of: a root of the ZC sequence, a length of the ZC sequence, or a cyclic shift value of the ZC sequence.

4. The method of claim 1, wherein the location identifier of the receiving apparatus comprises a coordinate of the location of the receiving apparatus in a two-dimensional or three-dimensional coordinate system with a reference point as an origin.

5. The method of claim 1, wherein the location identifier of the receiving apparatus comprises an identifier of a location region, and the receiving apparatus is located in the location region.

6. A method performed by a transmitting apparatus, comprising:
transmitting a wake-up signal (WUS), wherein a parameter of the WUS is associated with an associated location identifier, the parameter of the WUS is used for a receiving apparatus to transition from a first mode to a second mode based on a location identifier of the receiving apparatus, and the location identifier of the receiving apparatus indicates a location of the receiving apparatus.

7. The method of claim 6, wherein the parameter of the WUS is used for the receiving apparatus to transition from the first mode to the second mode based on a configuration parameter associated with the receiving apparatus, the configuration parameter associated with the receiving apparatus is obtained based on a mapping function and the location identifier of the receiving apparatus, an input of the mapping function comprises the location identifier of the receiving apparatus, and an output of the mapping function comprises the configuration parameter.

8. The method of claim 6, wherein the WUS comprises a Zadoff-Chu (ZC) sequence, and the parameter of the WUS comprises at least one of: a root of the ZC sequence, a length of the ZC sequence, or a cyclic shift value of the ZC sequence.

9. The method of claim 6, wherein the location identifier of the receiving apparatus comprises a coordinate of the location of the receiving apparatus in a two-dimensional or three-dimensional coordinate system with a reference point as an origin.

10. The method of claim 6, wherein the location identifier of the receiving apparatus comprises an identifier of a location region, and the receiving apparatus is located in the location region.

11. A receiving apparatus comprising:
at least one processor; and
a memory coupled to the at least one processor, the memory for storing instructions that, when executed by the at least one processor, cause the apparatus to perform:
receiving, in a first mode, a wake-up signal (WUS), wherein a parameter of the WUS is associated with an associated location identifier; and
transitioning from the first mode to a second mode based on the parameter of the WUS and a location identifier of the receiving apparatus, wherein the location identifier of the receiving apparatus indicates a location of the receiving apparatus.

12. The receiving apparatus of claim 11, wherein the transitioning from the first mode to the second mode based on the parameter of the WUS and the location identifier of the receiving apparatus comprises:
obtaining a configuration parameter associated with the receiving apparatus based on a mapping function and the location identifier of the receiving apparatus, wherein an input of the mapping function comprises the location identifier of the receiving apparatus, and an output of the mapping function comprises the configuration parameter; and
transitioning from the first mode to the second mode based on the parameter of the WUS and the configuration parameter associated with the receiving apparatus.

13. The receiving apparatus of claim 11, wherein the WUS comprises a Zadoff-Chu (ZC) sequence, and the parameter of the WUS comprises at least one of: a root of the ZC sequence, a length of the ZC sequence, or a cyclic shift value of the ZC sequence.

14. The receiving apparatus of claim 11, wherein the location identifier of the receiving apparatus comprises a coordinate of the location of the receiving apparatus in a two-dimensional or three-dimensional coordinate system with a reference point as an origin.

15. The receiving apparatus of claim 11, wherein the location identifier of the receiving apparatus comprises an identifier of a location region, and the receiving apparatus is located in the location region.

16. A transmitting apparatus comprising:
at least one processor; and
a memory coupled to the at least one processor, the memory for storing instructions that, when executed by the at least one processor, cause the apparatus to perform:
transmitting a wake-up signal (WUS), wherein a parameter of the WUS is associated with an associated location identifier, the parameter of the WUS is used for a receiving apparatus to transition from a first mode to a second mode based on a location identifier of the receiving apparatus, and the location identifier of the receiving apparatus indicates a location of the receiving apparatus.

17. The transmitting apparatus of claim 16, wherein the parameter of the WUS is used for the receiving apparatus to transition from the first mode to the second mode based on a configuration parameter associated with the receiving apparatus, the configuration parameter associated with the receiving apparatus is obtained based on a mapping function and the location identifier of the receiving apparatus, an input of the mapping function comprises the location identifier of the receiving apparatus, and an output of the mapping function comprises the configuration parameter.

18. The transmitting apparatus of claim 16, wherein the WUS comprises a Zadoff-Chu (ZC) sequence, and the parameter of the WUS comprises at least one of: a root of the ZC sequence, a length of the ZC sequence, or a cyclic shift value of the ZC sequence.

19. The transmitting apparatus of claim 16, wherein the location identifier of the receiving apparatus comprises a coordinate of the location of the receiving apparatus in a two-dimensional or three-dimensional coordinate system with a reference point as an origin.

20. The transmitting apparatus of claim 16, wherein the location identifier of the receiving apparatus comprises an identifier of a location region, and the receiving apparatus is located in the location region.
